(19) United States
(12) Patent Application Publication
(10) Pub. No.: US 2024/0375240 A1
(43) Pub. Date: Nov. 14, 2024

(54) PROFILE STRUCTURE FOR A COMPONENT OF A POWER TOOL, AND POWER TOOL HAVING A PROFILE STRUCTURE

(71) Applicant: Hilti Aktiengesellschaft, Schaan (LI)

(72) Inventors: Georg HOLZMEIER, Marktoffingen (DE); Stefan TEUFELHART, Bachern (DE); Ralf GREITMANN, Kaufering (DE); Helmut SPECHT, Irsee (DE)

(21) Appl. No.: 18/291,505

(22) PCT Filed: Aug. 8, 2022
(86) PCT No.: PCT/EP2022/072173

§ 371 Date: Jan. 23, 2024

(30) Foreign Application Priority Data
Aug. 24, 2021 (EP) 21192816.3

(51) Int. Cl. B24B 41/02; B24B 27/08; B25F 5/00; B26D 7/00

(52) U.S. Cl. CPC B24B 41/02; B24B 27/08; B25F 5/006; B26D 7/00

(57) ABSTRACT

A profile structure for a component of a power tool, wherein the profile structure has a front side and a rear side, and wherein the profile structure has at least two corrugations on one of the two sides and at least one corrugation on the other side. A power tool having a component that includes a profile structure. The power tool may preferably be a cutting or severing device, wherein the power tool component may be a cutting arm. The profile structure is particularly suitable for withstanding different loadings to which a component of a power tool may be exposed. The loadings may be for example bending about a horizontal or about a vertical axis or torsion. In a further aspect, the invention relates to a cutting arm for a power tool, wherein the cutting arm comprises a profile structure. The cutting arm may in particular be formed in one piece.

The present invention relates to a profile structure for a component of a power tool. In a further aspect, the invention relates to a power tool having a component that comprises a profile structure. The power tool may preferably be a cutting or severing device, wherein the power tool component may be a cutting arm. In a further aspect, the invention relates to a cutting arm for a power tool, wherein the cutting arm comprises a profile structure and is preferably formed in one piece.

### BACKGROUND OF THE INVENTION

The invention resides in the technical field of power tools, in particular in the field of cutting or severing devices. In said field, especially gasoline-driven devices are known, for example cut-off grinders, the grinding disk of which is driven by a combustion engine, wherein the transmission of movement from a motor of the cut-off grinder to the cut-off disk frequently takes place with a belt drive. In order to pick up the dust that accrues when working with the power tool, cutting or severing devices are often provided with a protective hood, at which it is possible to provide for example an opening for attaching a dust extraction system. For fastening the projecting protective hood, cut-off grinders have a cutting arm, which connects together a first unit of the power tool made up of the motor and handle and a second unit made up of the protective hood and cut-off disk. This cutting arm can be exposed to such high loadings during operation of the power tool that, in the worst case scenario, breakage of the cutting arm can occur. Such breakage of the cutting arm can result in undesired injuries and risks for the user of the power tool. The mechanical loadings that can cause the cutting arm to break may result for example from unbalance excitation of the rapidly rotating cutting blade or from severe vibrations at high motor rotation rates or motor speeds. The cutting arm of a power tool is also referred to as a cantilever in the literature.

For example, DE 10 2016 013 907 A1 describes a cantilever for a hand-held work device. According to DE 10 2016 013 907 A1, the cantilever is fastened to a motor housing of the work device and so, as a result, a two-part configuration is disclosed in that the motor housing and the cantilever represent separate components of the work device that are separated from one another. However, two-part cantilevers are disadvantageous because an interface is required for fastening them, and this frequently represents a predetermined breaking point on a power tool on account of the vibrations and mechanical loadings, such as bending or torsion. Furthermore, the transmission of forces takes place only at the screwing points and contact faces between the individual parts of the cantilever. As a result, the basic structure of the cantilever has to have particularly thick walls, and this can result in increased material consumption in production and therefore in higher material costs. Moreover, as a result of such a two-part cantilever, the power tool can have an undesirably high weight.

### SUMMARY OF THE INVENTION

In order to simplify the production of cantilevers, these are frequently used using the pot geometry. In cantilevers that are produced with the aid of the pot geometry, recesses are arranged either only on the front side or only on the rear side.

As a result of this one-sided arrangement of the recesses, the cantilevers produced with the aid of the pot geometry frequently have reduced mechanical stability and robustness with respect to tension and torsion. An example of a cantilever that can be produced with the aid of the pot geometry is described in DE 10 325 663 Al. An object on which the present invention is based is to overcome the above-described shortcomings and drawbacks of the prior art and to specify a profile structure for a component of a power tool with which, for example, a cutting arm can be provided with improved stability and stiffness with respect to different mechanical loadings. Furthermore, a power tool is intended to be specified which has a cutting arm with improved stability. A further concern of the invention is to keep the overall weight of the power tool as low as possible, i.e. to specify a particularly lightweight power tool.

In a first aspect, the invention relates to a profile structure for a component of a power tool, wherein the profile structure has a front side and a rear side, wherein the profile structure has at least two corrugations on one of the two sides and at least one corrugation on the other side. According to the invention, a corrugation represents preferably a channel-like recess, which, in the context of the present invention, is used to reinforce the power tool component with respect to deformations or vibrations. The profile structure according to the invention, having at least two corrugations on one of the two sides of the profile structure and a further corrugation on the other side of the profile structure, advantageously allows particularly great mechanical stability with respect to different loadings. Tests have shown that the profile structure is surprisingly stable with regard to bending about a horizontal or about a vertical axis or with regard to torsion. The increased mechanical stability becomes apparent in particular when different ones of these loading types interact such that the component with the corresponding profile structure is stressed particularly severely and inhomogeneously. With such superimposition of different loading types, the component with the profile structure having at least two corrugations has advantageously proven to be particularly robust and resistant with respect to any damage, or even breakage.

The profile structure has a front side and a rear side, wherein the front side and rear side of the profile structure are preferably referred to as “sides of the profile structure”. If the power tool component that comprises the profile structure is a cutting arm or a cantilever for a severing device or a saw, the front side of the profile structure is preferably present on the front side of the component, while the rear side of the profile structure is present on the rear side of the component. According to the invention, it is preferred that at least two corrugations are provided on the front side of the profile structure, while at least one corrugation is provided on the rear side of the profile structure. Of course, the corrugations can also be distributed the other way around on the front side and the rear side. According to the invention, it is preferred that the profile structure has an odd number of corrugations, for example three, five or seven corrugations, without being limited thereto. In the figures, profile structures with five corrugations are always shown, wherein in each case three corrugations are arranged on the front side and two corrugations are arranged on the rear side of the profile structure. This arrangement of the corrugations has proven to be mechanically particularly stable and robust.

According to the invention, it is preferred that the corrugations are arranged on both sides of the profile structure. This preferably means, according to the invention, that at least one corrugation is arranged on each side of the profile structure. Thus, the invention deviates specifically from those cantilevers or power tool components that are produced with the aid of the pot geometry, in which cavities or recesses are arranged only on one side of the cantilever or of the component. In the profile structure provided according to the invention, the corrugations are present on both sides of the profile structure such that, advantageously, a mechanically particularly stable two- or double-sided arrangement of the corrugations is achieved.

According to the invention, it is preferred that a number of n corrugations is provided on the front side of the profile structure, while a number of (n−1) corrugations is provided on the rear side of the profile structure. As a result, advantageously an odd number of corrugations is obtained, wherein the profile structure is formed preferably symmetrically about a virtual central axis of the component. According to the invention, it is particularly preferred that the corrugations of the profile structure are distributed or arranged symmetrically about the virtual central axis of the component. Advantageously, forces that arise on account of the symmetric configuration of the profile structure or of the corrugations can be distributed particularly well and cancel one another out.

For example, the profile structure can have five corrugations, of which three corrugations are open in a spatial direction “toward the front”, while two corrugations are open in a spatial direction “toward the rear”. In a numerical order from top to bottom, it is possible for example for the first, third and fifth corrugation to be arranged on the front side of the profile structure and the second and fourth corrugation to be arranged on its rear side. Since the number of corrugations is preferably odd, the profile structure preferably has a “middle” corrugation, through which preferably the virtual central axis of the profile structure or of the cutting arm extends. When there are five corrugations, the third corrugation, which is preferably arranged on the front side of the profile structure, preferably represents this middle corrugation. When there are three corrugations, it is possible preferably for the first and the third corrugation to be open toward the front, while the second corrugation, i.e. the middle corrugation, is open toward the rear.

If the power tool component that comprises the profile structure is a cutting arm or a cantilever for a severing device or a saw, preferably a plurality of axes extend through the component. These axes can be for example motor, transmission or tool axes. The corresponding axes are depicted for example in FIG. 4. The axes can extend substantially centrally through cylinders that extend from the front side of the profile structure in the direction of the rear side of the profile structure. This means, in other words, that the cylinders extend transversely through the component, wherein this transverse direction extends substantially perpendicularly to a longitudinal direction of the component. The motor axis, transmission axis and/or tool axis extend substantially parallel or collinearly to one another and are substantially perpendicular to the virtual central axis of the power tool component that comprises the profile structure. According to the invention, the cylinders through which the motor axis, the transmission axis and/or the tool axis extend can preferably be referred to as motor cylinder, transmission cylinder and/or tool cylinder.

On the rear side of the power tool component that comprises the profile structure, devices for connecting the motor cylinder, transmission cylinder and/or tool cylinder to the motor, the transmission and/or the tool of the power tool are provided. These preferably have a substantially circular area, which is preferably larger than a substantially likewise circular opening of the cylinder in the power tool component that comprises the profile structure. According to the invention, it is preferred that a corrugation region extends between the device for connecting the transmission cylinder to the transmission and between the device for connecting the tool cylinder to the tool. Preferably, the corrugation region can be formed in the region between the devices with the smallest spacing. In other words, the corrugation region of the profile structure extends between the device for connecting the transmission cylinder to the transmission and the device for connecting the tool cylinder to the tool, specifically in the region with the smallest spacing between these devices. The position of the corrugation region of the profile structure is illustrated for example in FIG. 7.

According to the invention, it is preferred that a corrugation region is arranged between a transmission cylinder and a tool cylinder of the power tool component. According to the invention, it is very particularly preferred that a corrugation region extends between a device for connecting a transmission cylinder to a transmission of the power tool and a device for connecting a tool cylinder to a tool of the power tool, wherein the corrugation region extends in particular in a region with the smallest spacing between a device for connecting a transmission cylinder to a transmission of the power tool and a device for connecting a tool cylinder to a tool of the power tool.

According to the invention, the region with the smallest spacing between the device for connecting the transmission cylinder to the transmission and the device for connecting the tool cylinder to the tool is referred to as the corrugation region. Said region is, according to the invention, preferably also referred to as the length of the profile structure, and so, put a different way, the corrugations can be said to extend continuously through the profile structure. According to the invention, it is preferred that the corrugations of the profile structure are formed continuously within the power tool component, i.e. are not interrupted in the longitudinal direction of the component. According to the invention, it is very particularly preferred that the corrugations extend between the transmission cylinder and the tool cylinder of the power tool component preferably in the form of a cantilever or cutting arm.

According to the invention, it is preferred that the profile structure has solid faces on its front side. The solid faces are present in particular on the front side of the power tool component, wherein the component comprises the profile structure. For example, the profile structure and the component may have two solid faces, which are preferably arranged symmetrically around a virtual central axis of the component. Examples of solid faces and their arrangement in a component, which is for example in the form of a cutting arm, are illustrated in FIG. 5. The solid faces preferably ensure that there are particularly low tensile stresses within the component that comprises the profile structure, and thus ensure particularly favorable mechanical properties with regard to stability and robustness of the power tool component. In particular, as a result of the provision of the solid faces on the front side of the profile structure and/or of the power tool component, significant deflection is counteracted, which may disadvantageously result in high tensile stresses and damage to the profile structure and/or to the power tool component.

According to the invention, it is preferred that the at least two corrugations of the profile structure extend in the longitudinal direction of the component. The corrugations may in particular extend substantially parallel to the belt drive of the power tool when the profile structure forms for example a cutting arm of a power tool.

In a second aspect, the invention relates to a cutting arm for a power tool, wherein the cutting arm comprises a profile structure having at least two corrugations. The cutting arm is preferably formed in one piece. According to the invention, it is preferred that the cutting arm represents a power tool component according to the invention. In a particularly preferred configuration, the invention relates to a cutting arm for a power tool, wherein the cutting arm has a profile structure with at least two corrugations and the cutting arm is formed in one piece. The expression “in one piece” preferably means, according to the invention, that a motor housing of the power tool and the component form a unit. Tests have shown that one-piece cutting arms, while having the same weight, usually have higher mechanical stability than two-piece cutting arms of the same weight. Furthermore, no interfaces are required, which are often complicated to integrate and may further reduce the mechanical stability.

Since the component is formed in one piece, it deviates specifically from multi-piece cutting arms or cantilevers as are known from the prior art.

Advantageously, the component can be configured in a particularly lightweight manner as a result of the provision of the at least two corrugations, and so, as a whole, a power tool having a low overall weight can be provided.

The configuration of the at least two corrugations becomes apparent preferably from a section illustration of the power tool component. If the component is a cutting arm of a cut-off grinder, a first virtual axis can extend within the cutting arm. A vertical section plane can extend substantially perpendicularly to this first virtual axis. If the cutting arm is sectioned along this vertical section plane and the resulting illustration depicted, this yields figures such as FIG. 1 to 3. The form of the section through the cutting arm of the power tool is preferably referred to, according to the invention, as profile structure. This profile structure is according to the invention when it has at least two corrugations, i.e. two channel-like recesses, as illustrated for example in FIG. 1 to 3. In this regard, the invention relates preferably to a profile structure for a component of a power tool, wherein the profile structure has at least two corrugations in a vertical sectional illustration. This preferably means, according to the invention, that the shape and configuration of the profile structure with the at least two corrugations become apparent in particular when an illustration of a vertical section through the component is observed. In other words, the profile structure can be made visible by a vertical section through the component. According to the invention, it is preferred that the profile structure becomes apparent from a vertical section at various points along the component. Preferably, the profile structure is present along more than 50% of the overall length of the component, wherein deviating profile structures or profiles can also arise at individual points or regions of the component. These points or regions of the component with deviating profile structures or profiles preferably make up less than 50%, i.e. a smaller part of the power tool component.

The profile structure preferably represents a slender structure for load absorption, which combines in particular different approaches from the mechanics of materials. The profile structure represents in particular a non-obvious combination of a standing double-T-shaped carrier profile, a lying double-T-shaped carrier profile, i.e. one rotated through substantially 90 degrees compared with the standing double-T-shaped carrier profile, and a thin-walled tube, wherein the standing double-T-shaped carrier profile is particularly stable with respect to bending about the horizontal axis, the lying double-T-shaped carrier profile is particular stable with respect to bending about the vertical axis, and the thin-walled tube is particularly resistant and robust with respect to torsion. The combination of these known profiles was not obvious to a person skilled in the art because none of the mentioned profiled has two or more corrugations. Rather, the profile which is in the form of a thin-walled tube points precisely away from the profile according to the invention with the two corrugations since, clearly, a thin-walled tube does not have any recesses or the like at all. Instead, the surface of a thin-walled tube is generally homogeneous without indentations or raised elements. In this regard, the profile structure differs precisely from the prior art through the provision of the at least two corrugations.

In the case of bending about the horizontal axis, the horizontal axis extends preferably substantially perpendicularly to a face of the cutting arm, i.e. substantially perpendicularly to a plane that is defined by the cutting arm. Preferably, the horizontal axis also extends substantially perpendicularly to a plane that is defined by the preferably disk-like tool of the power tool. The mentioned planes that are defined by the face of the cutting arm and the preferably disk-like tool of the power tool are preferably substantially parallel. Bending about a horizontal axis of the cutting arm is illustrated by way of example in FIG. 6.

In the case of bending about the vertical axis, the vertical axis extends preferably through the plane that is defined by the cutting arm or the preferably disk-like tool of the power tool. In other words, the vertical axis lies in this plane, in particular in a vertical direction, i.e., according to the invention, preferably from top to bottom or from bottom to top. Bending about a vertical axis of the cutting arm is illustrated by way of example in FIG. 5.

In the case of torsion, the axis of rotation extends preferably within the plane that is defined by the cutting arm or the preferably disk-like tool of the power tool, but in a horizontal direction, i.e., according to the invention, preferably from the front to the rear or from the rear to the front, wherein the tool of the power tool preferably indicates the front region of the power tool and the main body of the power tool, which may have for example a motor or handles, indicates the rear region of the power tool. Torsion about a virtual central axis of the cutting arm is illustrated by way of example in FIG. 4.

The slender structure, which forms the profile structure, is preferably a beam-like structure, which, as a result of the use of the at least two corrugations, is designed to optimally transmit or absorb the different loading types or a superimposition thereof. The profile structure, on account of its slender structure and the at least two corrugations, has a certain elasticity, and so the profile structure is advantageously designed to absorb elastic energy or deformation energy. As a result, the component that comprises the profile structure is protected particularly effectively against damage. The invention advantageously represents such an optimized combination of lightweight construction and the strength of materials, wherein the inventors have found a particularly balanced combination of easy producibility, mechanical stability, low weight and robustness. In particular, the invention represents a combination of the theoretically optimal cross sections of a cutting arm, which, on account its slender structure and the at least two corrugations, is particularly suitable for absorbing or withstanding the loads of the different loading types or a possible combination of the different loading types particularly well. In this way, the component having the profile structure is protected particularly effectively against breakage and other mechanical impairments.

According to the invention, it is preferred that the profile structure has reinforcement ribs. These reinforcement ribs may be arranged in particular in the corrugations. As a result of the provision of the reinforcement ribs, the profile structure can be reinforced further. Furthermore, shear between the different regions of the component can be transmitted particularly well. An essential advantage of the invention is that, on account of these shear fields, the loading forms “bending” and “torsion”, which are unfavorable from the point of view of lightweight construction, can be converted into the loading forms “tension” or “pressure”, which are more favorable because they are easier to withstand. As a result, the component can be particularly robust and stiff.

According to the invention, it is preferred that the reinforcement rips enclose an angle alpha with the corrugations, wherein the angle alpha lies in a range from 30 to 60°. Preferably, the reinforcement ribs can extend in a manner offset at an angle of 30 to 60° with respect to the corrugations. The wording that “the reinforcement ribs enclose an angle alpha with the corrugations” means, according to the invention, in particular that the reinforcement ribs enclose an angle with a virtual central axis of the cutting arm, wherein this angle can lie in a range from 30 to 60°. For example, the reinforcement ribs can extend in a manner offset at an angle of 45° with respect to the corrugations. The reinforcement ribs extend in particular obliquely within the corrugations, wherein a degree for the inclination of the reinforcement ribs can be given by the angle alpha.

According to the invention, it is preferred that the profile structure forms a sandwich structure. In particular as a result of the preferably slender, supporting profile structure, which has at least two corrugations, and the preferably thin-walled reinforcement ribs or reinforcements, the sandwich effect can be achieved, which contributes to the particularly high mechanical stability and robustness of the profile structure or of the component. In particular, the configuration of the profile structure allows an optimized force flow within the component. An optimized or ideal force flow is characterized, according to the invention, in that predominantly tensile or compressive loadings occur with regard to the power tool component. Tests have shown that the loads and/or loadings that occur are distributed by the invention, in particular the provision of the at least two corrugations, particularly uniformly in the power tool component that has the profile structure. In other words, the invention allows particularly homogeneous material loading, which effectively avoids any undesired breakages or mechanical impairments of the component.

According to the invention, it is preferred that the profile structure and/or the reinforcement ribs are present in a closed manner along the entire length of the power tool component. However, according to the invention, it may also be preferred that the profile structure and/or the reinforcement ribs are not present in a closed manner along the entire length of the power tool component. In the latter case, they may be present for example in a partially open and a partially closed manner along the length of the component. For example, the component may comprise perforated, punched and/or cut-out structures or subregions, without being limited thereto.

According to the invention, it is preferred that the profile structure comprises a profile structure wall. Preferably, the profile structure wall may have different thicknesses in different regions. This preferably means, according to the invention, that the thickness of the profile structure wall can be different in different regions. The expression “thickness of the profile structure wall” should, according to the invention, be understood as meaning preferably the material or wall thickness of the material from which the power tool component is produced. This is preferably the thickness of the material in the region of the profile structure, as is depicted in FIGS. 1 to 3. Preferably, the profile structure and the reinforcement ribs can vary in thickness along the length and/or across the width of the power tool component. This preferably means, according to the invention, that the thickness of the profile structure wall can be different in different regions of the component. In other words, the material of the component can have different material or wall thicknesses in different regions.

Preferably, the profile structure wall may have a thickness in a range of 1 to 5 mm, preferably in a range from 2 to 3 mm.

According to the invention, it is preferred that the profile structure and the reinforcement ribs are planar, flat and/or rectilinear. However, according to the invention, it may also be preferred that, in contrast thereto, they are not planar, flat and/or rectilinear.

According to the invention, it is preferred that the profile structure has regions with a honeycomb and/or lattice structure. This can be achieved for example in that the ribs extend obliquely and/or diagonally and in this way form honeycombs and/or lattices or other structures. According to the invention, it is particularly preferred that the rubs extend obliquely and/or diagonally in the peripheral and/or outer regions of the profile structure or of the cutting arm.

According to the invention, it is preferred that the profile structure is manufactured from more than one material. For example, a basic structure of the profile structure may comprise a metal, while the reinforcement ribs comprise a plastic.

Alternatively, the basic structure of the profile structure may comprise a carbon-fiber-reinforced plastic (CFRP), while the reinforcement ribs are formed from another plastic or metal. In the context of the present invention, on account of its low weight, aluminum can preferably be used as the metal. However, other metals or alloys are also possible.

According to the invention, it is very particularly preferred that the profile structure is optimized with regard to possible natural frequencies of the component that occur. For this purpose, it is possible to use, for example, simulation methods, which are used in order to further optimize the profile structure of the component and to achieve increased stiffness of the component.

According to the invention, it is preferred that the profile structure and/or the component has/have damping means for vibration damping. These damping means can be provided for example locally, i.e. in a localized manner, or extensively in a large area of the power tool component.

In a further aspect, the invention relates to a power tool having a component that comprises a profile structure having at least two corrugations. The definitions, technical effects and advantages that have been described for the profile structure and the component apply analogously to the power tool. According to the invention, it is preferred that the component is a cutting arm for a power tool, wherein the cutting arm is formed in one piece. Preferably, the power tool is a cutting or severing device, wherein the power tool preferably has a disk-like tool. The disk-like tool may in particular be a cut-off disk or a cutting blade, wherein the preferably disk-like tool is arranged preferably in a front region of the power tool or of the cutting arm of the power tool.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

Identical and similar components are denoted by the same reference signs in the figures, in which:

FIG. 1 shows an illustration of a vertical section through a component of a power tool, wherein the vertical section reveals a preferred configuration of the profile structure

FIG. 2 shows an illustration of a vertical section through a component of a power tool, wherein the vertical section reveals a second preferred configuration of the profile structure

FIG. 3 shows an illustration of a vertical section through a component of a power tool, wherein the vertical section reveals a [[second]] third preferred configuration of the profile structure

FIG. 4 shows a side view of a preferred embodiment of the cutting arm, wherein the cutting arm implements torsion about a central axis

FIG. 5 shows a side view of a preferred embodiment of the cutting arm, wherein the cutting arm implements bending about a vertical axis

FIG. 6 shows a side view of a preferred embodiment of the cutting arm, wherein the cutting arm implements bending about a horizontal axis

FIG. 7 shows a side view of a preferred embodiment of the cutting arm to illustrate the corrugation region

FIG. 8 shows a side view of a preferred embodiment of the cutting arm to illustrate a profile structure with five corrugations

FIG. 9 shows a side view of a preferred embodiment of the cutting arm to illustrate a profile structure with five corrugations

### DETAILED DESCRIPTION

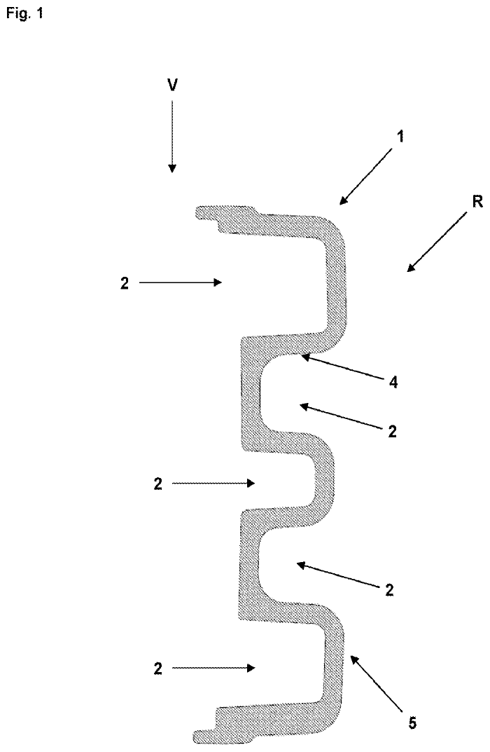

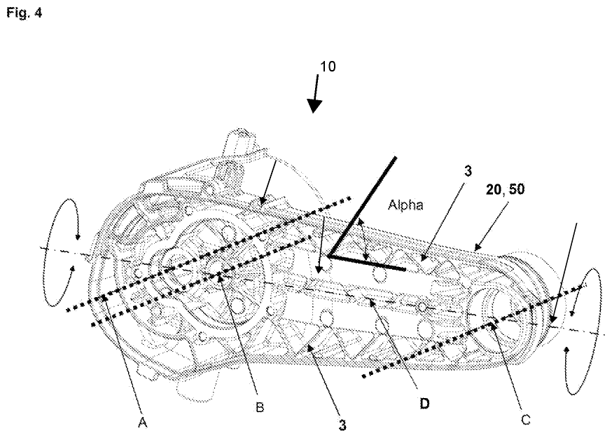

The figures show preferred embodiments of the profile structure 1. In particular, the figures illustrate vertical sections through a component 20 of a power tool 10 (see, e.g, FIG. 4 with cutting arm 50 as the component), wherein the profile structure 1 of the component 20 of the power tool 10 is revealed by this illustration of the vertical section. The profile structure 1 has at least two corrugations 2, wherein, for example, the profile structure 1 illustrated in FIG. 1 has five corrugations 2. In the exemplary embodiment of the present invention that illustrated in FIG. 1, the corrugations 2 are formed by channel-like recesses, which are preferably formed one above another and with substantially parallel side walls. The exemplary embodiment of the invention that is illustrated in FIG. 1 has, for example, three corrugations 2 that are open in the direction of the left-hand half of the image and two corrugations 2 that are open in the direction of the right-hand half of the image. The cutting arm illustrated in FIG. 1 thus has a total of five corrugations 2. The profile structure 1 has profile structure walls 4, which may have different thicknesses. In particular, the profile structure walls 4 can be thicker at the transition regions between a corrugation and a profile face of the profile structure 1 than in the region of the side walls of the corrugations 2. The outwardly facing surfaces of the component 20 of the power tool 10 are preferably referred to as a profile faces according to the invention. The exemplary embodiment of the invention that is illustrated in FIG. 1 represents substantially a basic structure 5 of the profile structure 1, wherein the profile structure 1 illustrated in FIG. 1 has, for example, no reinforcement ribs 3 (see also, FIG. 4). In the exemplary embodiment of the invention that is illustrated in FIG. 1, the corrugations 2 are open on the left-hand side and closed on the right-hand side of the figure.

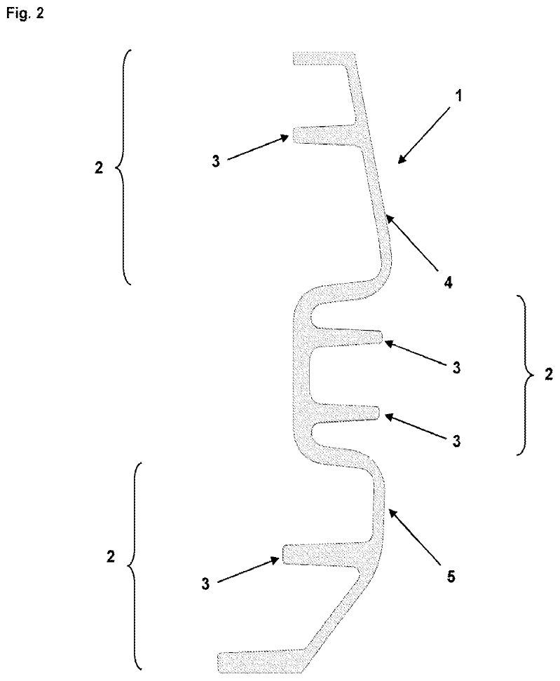

FIG. 2 illustrates an alternative or second configuration of the profile structure 1. The exemplary embodiment of the invention that is illustrated in FIG. 2 has a total of three corrugations 2, wherein two corrugations 2 are open in the direction of the left-hand half of the image and one corrugation 2 is open in the direction of the right-hand half of the image. The corrugations 2 and their dimensions are illustrated in the figures by way of braces.

Furthermore, the embodiment of the invention that is illustrated in FIG. 2 comprises reinforcement ribs 3, which are arranged preferably in the corrugations 2. The reinforcement ribs 3 give the profile structure 1 even greater stability and robustness. In the exemplary embodiment of the invention that is illustrated in FIG. 2, four reinforcement ribs 3 can be seen, for example. The remaining structure, which does not form a reinforcement rib 3, is the basic structure 5 of the profile structure 1.

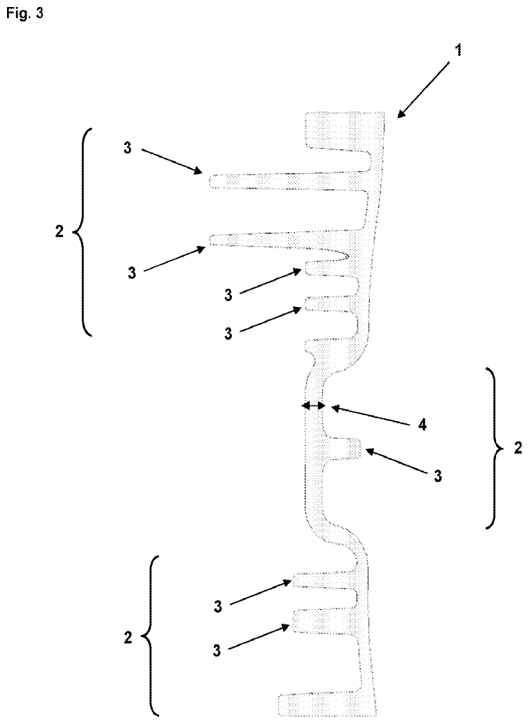

FIG. 3 illustrates an alternative or third configuration of the profile structure 1. The profile structure 1 illustrated in FIG. 3 has two corrugations 2 and a series of reinforcement ribs 3. The exemplary embodiment of the invention that is illustrated in FIG. 3 likewise has a total of three corrugations 2, wherein two corrugations 2 are open in the direction of the left-hand half of the image and one corrugation 2 is open in the direction of the right-hand half of the image. Present in the corrugations 2 are a series of reinforcement ribs 3, which give the profile structure 1 even greater stability.

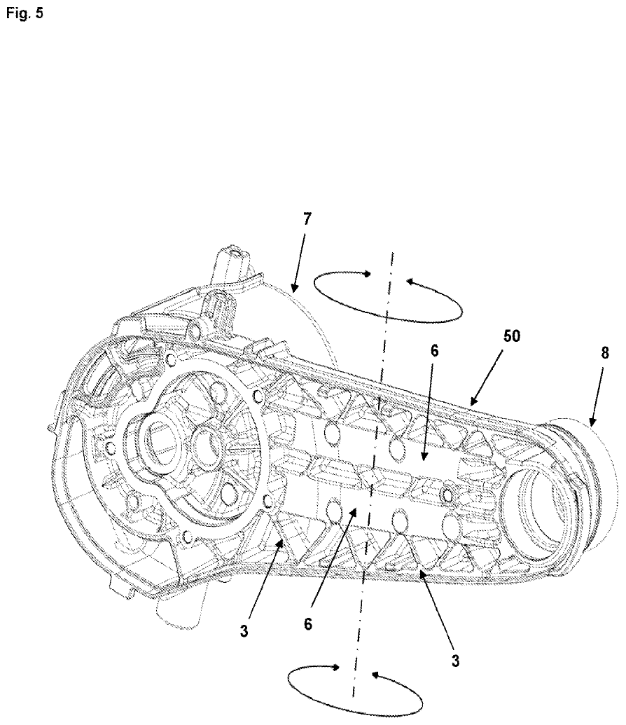

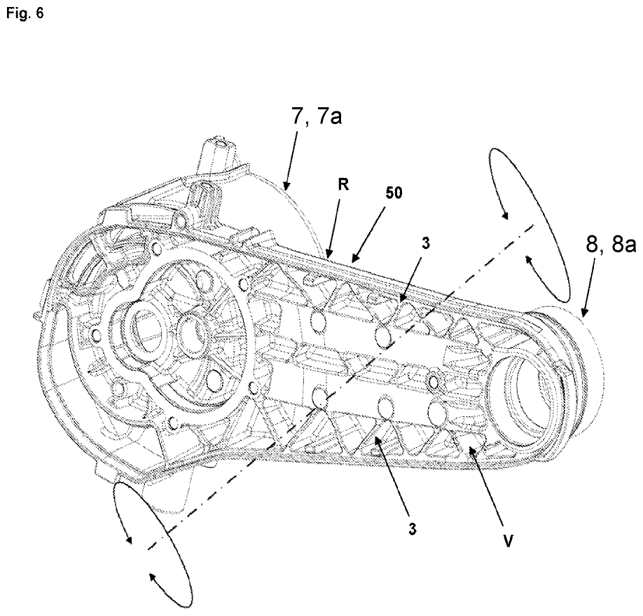

FIGS. 4-6 show side views of preferred embodiments of the cutting arm 50. In this case, FIG. 4 shows how the cutting arm 50 implements torsion about a central axis D of the cutting arm 50, while FIGS. 5 and 6 illustrate bending about a vertical (FIG. 5) and a horizontal (FIG. 6) axis of the cutting arm 50, respectively. The central axis, and the vertical and the horizontal axis of the cutting arm 50 are illustrated by dashed lines in FIGS. 4 to 6, which extend through the cutting arm 50 or lie within the cutting arm 50. The directions of bending or rotation of the cutting arm 50 under the respective loading types are indicated in FIGS. 4 to 6 by the round arrows at the ends of the axes.

FIG. 4 furthermore shows the three axes A, B and C, which may extend through different points of the cutting arm 50. The first axis A represents the motor axis of the power tool 10. The second axis B represents the transmission axis of the power tool 10 and is connected to one of the two pulleys of the belt drive of the power tool 10. The third axis C represents the tool axis of the power tool 10 and is connected to the other of the two pulleys of the belt drive of the power tool 10. The tool 11 of the power tool 10 can rotate about the third or tool axis C of the cutting arm 50. The tool 11 may be for example a disk-like tool such as a cut-off or cutting disk, wherein the tool 11 is designed to rotate about the tool axis C. Furthermore, FIG. 4 depicts the angle alpha, which is preferably enclosed by the reinforcement ribs 3 and the corrugations 2 or the reinforcement ribs 3 and the torsion axis of the cutting arm 50. The torsion axis of the cutting arm 50 coincides in particular with the virtual central axis D of the cutting arm 50.

In FIG. 5, solid faces 6 are illustrated, which are arranged in particular on the front side V of the profile structure 1 or of the cutting arm 50. These solid faces 6 are preferably arranged substantially in a symmetrically distributed manner about the virtual central axis D of the cutting arm 50. The solid faces 6 advantageously prevent deflection of the cutting arm 50 and thus result in reduced tensile stress within the component 20 or the cutting arm 50. As a result, the component 20 or the cutting arm 50 of the power tool 10 is protected particularly effectively against damage caused by excessive tensile stresses.

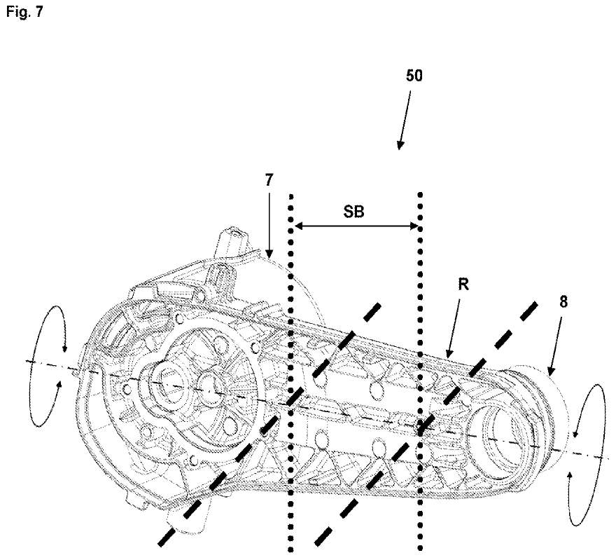

FIG. 7 shows a side view of a preferred embodiment of the cutting arm 50, wherein in particular the corrugation region SB of the cutting arm 50 of the power tool 10 is depicted. The cutting arm 50 can have a transmission cylinder 7 and a tool cylinder 8, wherein the corrugation region SB extends preferably between the transmission cylinder 7 and the tool cylinder 8. Preferably, the second axis B (see, e.g., FIG. 4) of the cutting arm 50, i.e. the transmission axis B, extends through the transmission cylinder 7, while the third axis C (see, e.g., FIG. 4) of the cutting arm 50, i.e. the tool axis C, extends through the tool cylinder 8. The transmission cylinder 7 and the tool cylinder 8 can each have an outside diameter on the rear side R of the cutting arm 50, wherein the corrugation region SB of the profile structure 1 extends in particular in a region with the smallest spacing between transmission cylinder 7 and the tool cylinder 8. This smallest spacing is preferably arranged between the outside diameters of the transmission cylinder 7 and of the tool cylinder 8. The components of the transmission cylinder 7 and of the tool cylinder 8 on the rear side R of the cutting arm 50 are referred to, according to the invention, preferably as the device 7a for connecting a transmission cylinder 7 to a transmission of a power tool 10 and as the device 8a for connecting a tool cylinder 8 to a tool 11 of the power tool 10. Reference arrows for the transmission cylinder 7 and the tool cylinder 8 are illustrated in particular in FIGS. 5 to 7, wherein the arrows each point in particular to the outside diameters of the transmission cylinder 7 and of the tool cylinder 8. Starting from these outside diameters, dashed lines are drawn, between which the corrugation region SB of the profile structure 1 or of the component 20 extends.

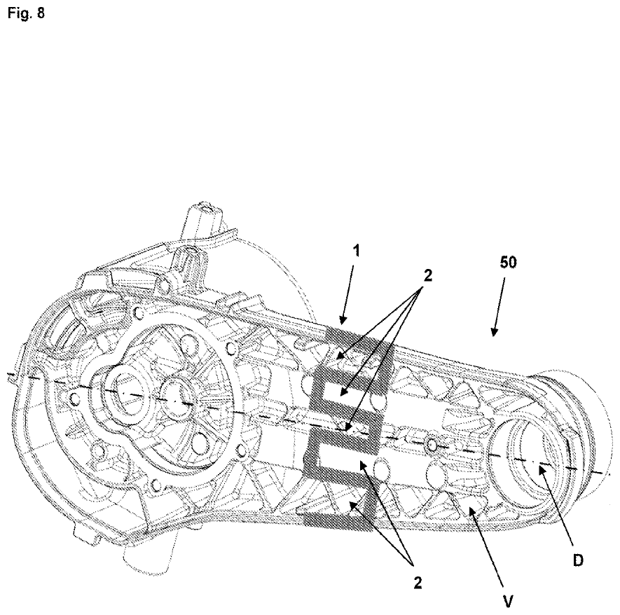

FIG. 8 shows a side view of a preferred embodiment of the cutting arm 50, wherein in particular a profile structure 1 with five corrugations 2 is depicted. To clarify the corrugations 2, bars are shown in FIG. 8, which are intended to mark the side walls of the corrugations 2. As is apparent from the exemplary embodiment of the invention that is shown in FIG. 8, the openings of the corrugations 2 can be oriented both in the direction of the front side V and in the direction of the rear side R of the profile structure 1 or of the cutting arm 50. This means that the corrugations 2 are arranged both on the front side V and on the rear side R of the profile structure 1 or of the cutting arm 50. Preferably, the corrugations 2 have their openings alternately in the direction of the front side V and in the direction of the rear side R of the profile structure 1 or of the cutting arm 50. In the examples illustrated in the figures, usually three corrugations 2 are arranged or oriented such that their openings are oriented in the direction of the front side V of the profile structure 1 or of the cutting arm 50. These corrugations 2 are, according to the invention, referred to as “corrugations 2 that are arranged on the front side V of the profile structure 1 or of the cutting arm 50”, while the corrugations 2 that are arranged on the rear side R of the profile structure 1 or of the cutting arm 50 are open in the direction of the rear side R of the profile structure 1 or of the cutting arm 50. In the context of the present invention, the corrugations 2 are arranged both on the front side V and on the rear side R of the profile structure 1 or of the cutting arm 50, such that a two- or double-sided arrangement of corrugations 2 on a component 20, such as a cutting arm 50 for a power tool 10, is obtained.

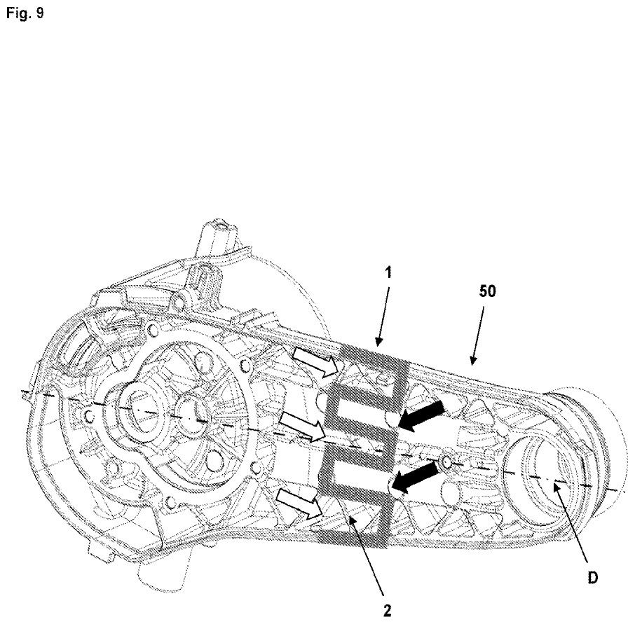

The opening direction of the corrugations 2 is illustrated in particular in FIG. 9. The three corrugations 2 that are open toward the front side V of the profile structure 1 or of the cutting arm 50 are marked by a white arrow in FIG. 9, while the two corrugations 2 that are open toward the rear side R of the profile structure 1 or of the cutting arm 50 are marked by a black arrow in FIG. 9. The three corrugations 2 marked by a white arrow are thus corrugations 2 that are arranged on the front side V of the profile structure 1 or of the cutting arm 50, while the two corrugations 2 marked with a black arrow are those corrugations 2 that are arranged on the rear side R of the profile structure 1 or of the cutting arm 50.

### LIST OF REFERENCE SIGNS

1 Profile structure
2 Corrugation
3 Reinforcement rib
4 Profile structure wall
5 Basic structure
6 Solid faces
7 Transmission cylinder
8 Tool cylinder
10 Power tool
11 Tool
20 Component
50 Cutting arm
A First axis, motor axis
B Second axis, transmission axis
C Third axis, tool axis
D Virtual central axis of the cutting arm
S Corrugation region
V Front side
R Rear side
alpha Angle between reinforcement ribs and corrugations or virtual central axis

What is claimed is:

1-15. (canceled)

16: A profile structure for a component of a power tool, the profile structure comprising:
a front side and a rear side, at least two corrugations on one of the front and rear sides and at least one corrugation on the other of the front and rear sides.

17: The profile structure as recited in claim 16 wherein the corrugations extend in the longitudinal direction of the component.

18: The profile structure as recited in claim 16 wherein the corrugations are arranged substantially symmetrically about a virtual central axis of the component of the power tool.

19: The profile structure as recited in claim 16 wherein the courrugations number n corrugations on the front side V and (n−1) corrugations on the rear side.

20: The profile structure as recited in claim 16 further comprising reinforcement ribs.

21: The profile structure as recited in claim 20 wherein the reinforcement ribs are arranged in the corrugations.

22: The profile structure as recited in claim 16 wherein the reinforcement ribs enclose an angle alpha with a virtual central axis, wherein the angle alpha lies in a range from 30 to 60°.

23: The profile structure as recited in claim 16 further comprising has solid faces on the front side.

24: The profile structure as recited in claim 16 wherein the profile structure is manufactured from more than one material, wherein a basic structure of the profile structure includes a metal or reinforcement ribs include a plastic.

25: A power tool comprising a component including the profile structure as recited in claim 16.

26: The power tool as recited in claim 25 comprising a corrugation region arranged between a transmission cylinder and a tool cylinder of the component.

27: The power tool as recited in claim 25 wherein the component is a cutting arm for a power tool.

28: The power tool as recited in claim 25 wherein the power tool is a cutting or severing device or a saw.

29: A cutting arm for a power tool, the cutting arm comprising the profile structure as recited in claim 16.

30: The cutting arm as recited in claim 29 wherein the cutting arm is formed in one piece.
